(19) United States
(12) Patent Application Publication
(10) Pub. No.: US 2023/0406773 A1
(43) Pub. Date: Dec. 21, 2023

(54) LOW DENSITY LIGHTWEIGHT PARTICLES FOR USE IN GYPSUM AND OTHER CEMENTITIOUS MIXTURES

(71) Applicant: Schabel Polymer Technology, LLC, Westlake, OH (US)

(72) Inventors: Norman G. Schabel, JR., Rocky River, OH (US); David L. Schabel, Avon, OH (US)

(21) Appl. No.: 18/210,388

(22) Filed: Jun. 15, 2023

Related U.S. Application Data
(60) Provisional application No. 63/352,455, filed on Jun. 15, 2022.

(51) Int. Cl. C04B 28/14; C04B 18/02; C04B 14/18; C04B 16/08

(52) U.S. Cl. CPC C04B 28/14; C04B 18/027; C04B 14/18; C04B 16/08; C04B 2111/40

(57) ABSTRACT

A composition is provided including a low density lightweight gypsum or cementitious mix including low density lightweight mineral or polymer based particles with compressive strengths of a specified value and densities within a specified range. A composition is also disclosed that includes chemical modification to control the time and place of set and cure characteristics.

### CROSS-REFERENCE TO RELATED APPLICATIONS

The present application claims priority to U.S. Provisional Patent Application No. 63/352,455, filed Jun. 15, 2022, and titled “LOW DENSITY PARTICLES FOR USE IN GYPSUM AND OTHER CEMENTITIOUS MIXTURES,” the entire contents of which is incorporated herein by reference in its entirety.

### FIELD

The field relates generally to the use of low density lightweight particles in gypsum mixtures and other cementitious composite mixtures to reduce overall system weight and/or impart other performance advantages to the system.

### BACKGROUND

Conventional concrete is very well known and based on gypsum, Portland, CAC and related binders, chemical admixtures and mineral aggregates such as sand, gravel, limestone, clay and the like. Properties are generally in the weight range of 140 to 150 pcf and, with variations, in the 110-130 pcf range. Corresponding compressive strengths reported at 28 days can be 2,200-3,500 psi, with some variations 4,500 psi or more. In various mixtures, the dry products are combined with water and the irreversible hydration reaction occurs in the mixer delivery truck, or with bag mixes at the application site.

### SUMMARY

The following presents a simplified summary of the disclosure to provide a basic understanding of some aspects described in the detailed description.

Low Density Lightweight particles may be used in gypsum and other cementitious systems to reduce weight and/or impart additional performance benefits to the final mixture. As described herein, functional low density lightweight particle(s) and improved lightweight gypsum and/or cementitious composite mixtures and other lightweight composite mixtures are disclosed.

The present invention provides lightweight gypsum and cementitious mixtures with reduced weight characteristics, such as 70, 80, 90 pcf, with achieved strengths of 3,000, 3,500, 4,000, 4,500 psi, as well as improved working characteristics and smooth surface profile that allow final floor applications. Further examples are shown that reach lower weights of 25, 30, 35, 40, 45, 50 pcf for applications that do not require standard compressive strengths, such as 200, 250, 300, 350, 400, 450, 500 psi where weight savings are more important than strength, such as lightweight deep fill floor leveling and or multistory floor leveling applications where weight or deadload of a structure are critically important. These ultra lightweight systems are not based on unstable gas, chemical, or lightweight foaming agents that degrade over time or with exposure to shear forces from mixing, pumping, placing, troweling and the like.

It is shown that these lightweight gypsum or cementitious systems are formulated with unique and very low density engineered or-processed aggregates based on polymers, minerals, glass, silica, silicates and the like.

It is also shown that lightweight gypsum and cementitious systems are produced with additive and admixture combinations that allow control of the time and place to influence working time, set time, cure time and final properties of the system

In aspects, a composition is provided comprising a low density lightweight gypsum or cementitious mix comprising low density lightweight mineral based particles with compressive strengths of greater than 2,000 psi and densities within a range from about 55 pcf to about 95 pcf.

In aspects, the composition further comprises a mineral based perlite particle with a specific gravity of between 0.3 g/cc to 0.9 g/cc and an average particle size of 50 to 300 microns in combination with the gypsum or cementitious mix.

In aspects, the composition further comprises silicon dioxide, silicon aluminate, vermiculite, perlite, fly ash, cenospheres or glass derived particle with a specific gravity of 0.1 to 0.9 g/cc or 1.8 to 2.4 g/cc and average particle size of 20 to 300 microns in combination with a gypsum and/or cementitious mixture.

In aspects, the composition further comprises one or more of chemical additives, surface modifiers, thixotropes, retardants, accelerators or admixtures in conjunction with low density lightweight mineral based particles and gypsum or cementitious systems to achieve homogeneity of the mix of separation less than about 20% and an initial set time within a range from about 60 minutes to about 130 minutes after being mixed with water.

In aspects, a composition comprises an ultra low density lightweight gypsum or cementitious mix comprising low density lightweight polymer based particles with compressive strengths of greater than 50 psi and densities within a range from about 15 pcf to about 55 pcf.

In aspects, the low density lightweight polymer based particles comprise an average nominal specific gravity within a range from about 0.001 g/cc to about 1.25 g/cc.

In aspects, the low density lightweight polymer based particles comprise an average particle size within a range from about 1 micron to about 8 mm.

In aspects, the low density lightweight polymer based particles comprise polymers and copolymers, comprising one or more of polyolefin, PP, EPP, LDPE, HDPE, EPE, Polystyrene, EPS, PPO, carbon or graphite modified polymers, PVC, PVDC, PMU, melamine, polyester, ABS, polyamide, urethane, epoxy, foamed rubber, crumb rubber, or EPDM.

In aspects, the composition further comprises one or more chemical additives, surface modifiers, thixotropes, retardants, accelerators, or admixtures in conjunction with low density lightweight polymer based particles and gypsum or cementitious systems to achieve homogeneity of the mix of separation less than about 20% and an initial set time within a range from about 60 minutes to about 130 minutes after being mixed with water.

In aspects, a gypsum or cementitious mixture is provided having a density of less than about 130 pcf and having a controlled working or set time of at least 60 minutes to enable the delivery of the system via a mixer truck, pump truck, bulk truck or ready mix truck.

In aspects, the gypsum or cementitious mixture further comprises a low density lightweight gypsum or cementitious mix comprising low density lightweight mineral based particles with compressive strengths of greater than 2,000 psi and densities within a range from about 55 pcf to about 95 pcf.

In aspects, the gypsum or cementitious mixture further comprises an ultra low density lightweight gypsum or cementitious mix comprising low density lightweight polymer based particles with compressive strengths of greater than 50 psi and densities within a range from about 15 pcf to about 55 pcf.

In aspects, the gypsum or cementitious mixture further comprises a conventional gypsum or cementitious mixture with densities within a range from about 90 pcf to about 130 pcf with compressive strengths of up to 5,500 psi.

In aspects, the gypsum or cementitious mixture further comprises one or more chemical additives, surface modifiers, thixotropes, retardants, accelerators, or admixtures in conjunction with low density lightweight mineral and/or polymer based particles and gypsum or cementitious systems to achieve homogeneity of the mix of separation less than about 20% and an initial set time within a range from about 60 minutes to about 130 minutes after being mixed with water.

In aspects, the chemistry and particles in the mix design accommodate initial set time within one hour or delayed up to 12 hours.

In aspects, the initial set of the mixture is accelerated or retarded through the use of a supplemental chemical or other activators for use on-site.

In aspects, the density is within a range from about 60 pcf to about 130 pcf and the compressive strength is greater than about 10,000 psi.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 illustrates a form (side view) poured with a homogenous lightweight gypsum or cementitious composite mixture using low density particles;

FIG. 2 illustrates a microscopic image of low density lightweight particles derived from processed engineered perlite mineral;

FIG. 3 illustrates a form (top view) poured with a homogeneous lightweight gypsum or cementitious composite binder mixture using low density particles;

FIG. 4 illustrates a form (side view) showing low density lightweight particles coarse/fine aggregates and admixtures in a homogeneous lightweight gypsum, cementitious or resin binder system; and

FIG. 5 illustrates a composition similar to FIG. 4 but with retarders, accelerators, and other chemical set time modifiers.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc. —are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising,” “including,” and variations thereof shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

Reference will now be made in detail to exemplary embodiments of the present invention, examples of which are illustrated in the accompanying drawings and sample formulas. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention. In addition, certain features described herein are also described in U.S. Pat. No. 7,770,691 (“Lightweight pelletized materials”), the entire disclosure of which is hereby incorporated by reference.

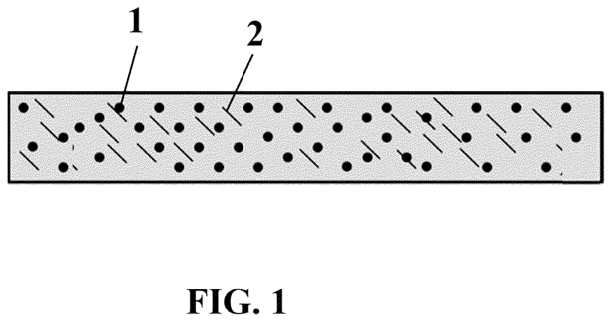

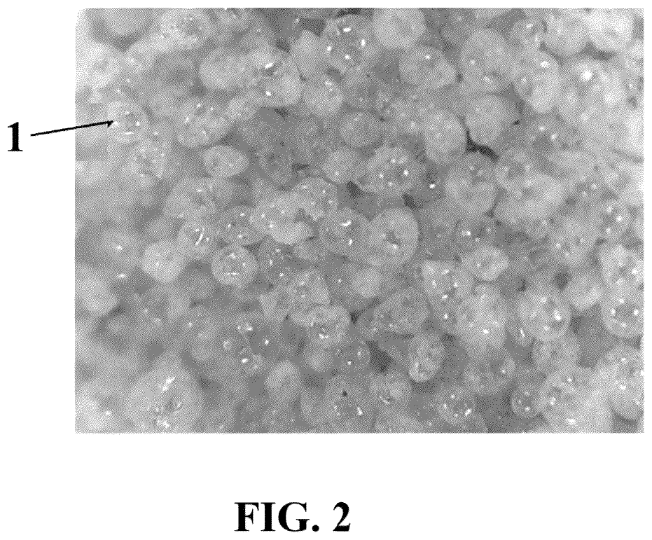

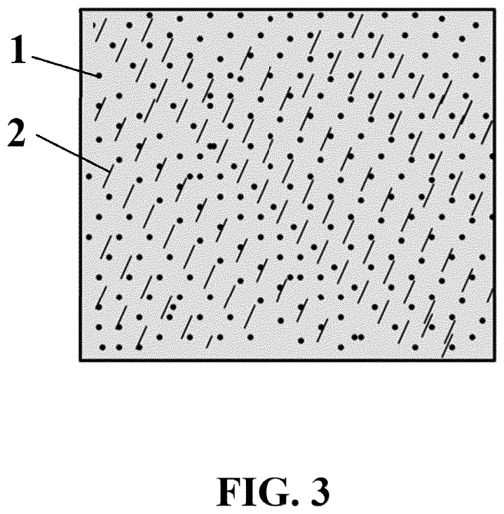

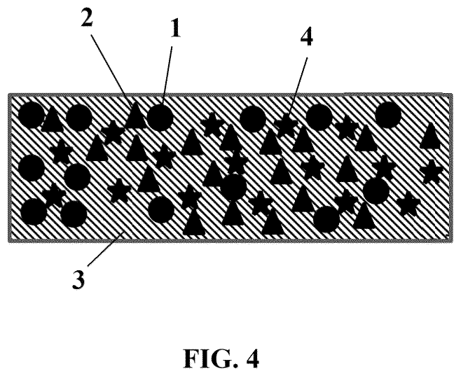

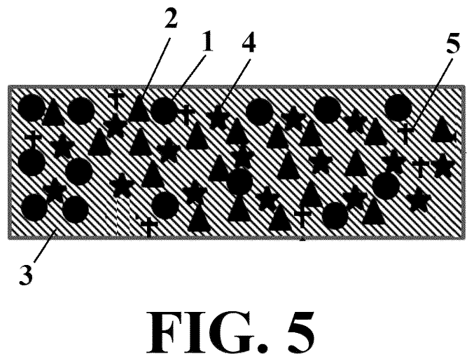

Initially, with brief reference to FIGS. 1-3, reference number 1 refers to a lightweight additive and reference number 2 refers to a composite binder. In FIG. 4, the lightweight particles (e.g., reference number 1) are illustrated generically as circles, while reference number 2 refers to coarse/fine aggregates illustrated generically as triangles. Reference number 3, illustrated generically as an angled line, refers to a binder (e.g., cement, pozzolan, resin, acrylic). Reference number 4, illustrated generically as a star, refers to admixtures. FIG. 5 is similar to FIG. 4 but for the addition of reference number 5, illustrated generically as a cross, which refers to retarders, accelerators, and other chemical set time modifiers.

In some embodiments, the plurality of low density particles comprise one or more of polymer or glass microspheres, foamed glass particles, expanded processed minerals and ceramics such as carbon, silicon dioxide, aluminosilicate, Amorphous Alumina Silicate, alumina, clay, vermiculite, perlite or engineered processed perlite. Polymers and copolymers can include one or more of polyolefin, PP, EPP, LDPE, HDPE, EPE, Polystyrene, EPS, PPO, carbon or graphite modified polymers, PVC, PVDC, PMU, melamine, polyester, ABS, polyamide, urethane, epoxy, foamed rubber, crumb rubber, EPDM, and the like.

In some embodiments, the gypsum and cementitious mixture is comprised of one or more materials, such as gypsum, calcium sulfate, alpha gypsum, beta gypsum, calcium hemihydrate, calcium dihydrate, calcium silicate, calcium aluminate, calcium sulfoaluminate, calcium oxide, calcium dioxide, calcium hydroxide, cement fondu, silicon dioxide, calcium carbonate, limestone, magnesium carbonate, magnesium oxide, magnesium silicate, sodium carbonate, Portland cement, Portland lime cement, pozzolan, geopolymer cement, hydraulic cement, slag cement, high alumina cement, white cement, UHPC, metakaolin, silica fume, fly ash, and the like.

In some embodiments, the lightweight composite composition further comprises one or more additives, surface modifiers, thixotropes, retardants, accelerators and/or admixtures as are commonly used in gypsum or cementitious formulations.

In some embodiments, the low density lightweight polymer particle is processed by being heated or expanded up to 160° F., 200° F., 250° F., 350° F., 400° F. or greater. In some embodiments, the low density lightweight mineral particles are heated, melted, calcined and/or kilned at temperatures up to 1,000° F., 1,500° F., 2,000° F., 2,500° F. or greater. Furthermore, in other embodiments, a low density lightweight mineral particle could be surface coated and or encapsulated or otherwise treated or modified to encase the base particle.

In some embodiments, the low density lightweight particle presents unique drying characteristics to the binder system due to chemistry, pH and/or properties of the particle.

In some embodiments, the low density lightweight particle displays surface adsorption and/or absorption characteristics promoting the incorporation of the low density lightweight particle within the binder system. The absorption could be in the range of <5%, <10%, 15%, 20%, 25%, 30%, 35%, 40% or 45% by weight.

In some embodiments, the addition of low density lightweight particles allow moisture to evaporate more rapidly in the composite system, thus allowing faster dry and cure characteristics of the system by hours or days as compared to the commonly used products.

In some embodiments, the low density lightweight particles have a closed cell structure, particle shell, smooth surface profile or reduced absorption surface making the particle less porous.

In some embodiments, the addition of low density lightweight particles promotes and enhances the hydration phase of the composite system.

In some embodiments, the low density lightweight particle(s) may be open cell or closed cell, modified cell shell or surface modified or mixtures thereof.

In some embodiments, a lightweight composite composition comprises a plurality of low density lightweight particles comprising a volume of at least about 15 to 25% by volume, 25 to 40% by volume, 40 to 60% by volume, 60 to 75% by volume, 75 to 90% by total volume of the lightweight composite composition. The plurality of low density lightweight particles comprise an average nominal specific gravity within a range from about 0.001 g/cc to 0.01 g/cc, 0.01 to 0.1 g/cc, 0.1 to 0.5 g/cc, 0.5 to 0.8 g/cc, 0.8 to 1.25 g/cc. In some embodiments, these lightweight low density particles have an average particle size within a range from about 1 to 15 microns, 10 to 200 microns, 40 to 300 microns, 200 to 1,000 microns, 0.4 to 2 mm, 1 to 3 mm, 2 to 4 mm, 3 to 8 mm.

In some embodiments, the additives and/or the admixtures comprise a volume that is within a range from about 0 to 2.5%, 2.5 to 5%, 5 to 10%, 10 to 15% of a total volume of the lightweight composite composition.

In some embodiments, the pH of the low density lightweight particle can be acidic, basic or neutral, generally in a range of 5.5 to 8, 6 to 9, 8 to 10, 9 to 11.

In some embodiments, there are improvements on system shrinkage, expansion, pumpability, surface profile, density, strength, slump and/or flowability when using low density lightweight particles.

In some embodiments, there can be an improvement in thermal insulation through the use of low density lightweight particles with an R-value of the lightweight composite composition is within a range from about 0 to about 5 per inch, 1 to 3, 2 to 4, 3 to 5.

In some embodiments, there can be an improvement in acoustical attenuation or sound transmission/absorption through the use of low density lightweight particles.

In some embodiments, the plurality of low density lightweight particles comprise one or more of the following shapes: rounded, spherical, sub-round, angular, sub-angular, cylindrical, pancake, oblong, trilobal, polygonal, disc, platelet, lamellar, regular crystalline, or irregular crystalline.

In some embodiments, the use of low density lightweight particles improves sound transmission coefficient and decibel levels of the composite system. STC values as measured by ASTM E413 are highly dependent on thickness and other structural factors, but could increase by up to 2 units, 3 units, 4 units and more.

In some embodiments, using low density lightweight particles provides weight reduction of 15 to 40% with minimal compressive strength reduction of perhaps up to 10 to 15%. In some embodiments, compressive strengths can be up to 3,000, 3,500, and 4,000+ psi. In some embodiments, compressive strengths can be up to 15,000 psi or more.

In some embodiments, the use of low density lightweight particles promotes self-leveling characteristics for better pumpability, handling, workability, placement and improved surface profile/finish compared to conventional concrete. In some embodiments, lightweight gypsum or cementitious formulations can pump up to 350 feet or more with a throughput of up to 25 gallons per minute at only 20 psi pressure based on a 1¼ ″ hose on a 2″ piston pump.

Decreasing the weight of formulated systems from conventional 110 to 150 pcf to possibly 25, 30, 35, 40, 60, 70, 80 or 90 pcf has numerous benefits, which may include:
Worker Safety: If workers are able to lift and move materials that weigh less than standard products, there is less physical stress and less risk of injuries on the job.
Shipping: With reduced weight, more material may fit on a truckload and effectively decrease overall freight costs, reduce the number of trucks being loaded and shipped and decrease the carbon footprint of deliveries.
Processing/Application: If the formulated system weighs less, it takes less energy to mix the batch (less weight to move requires less energy to move it) and if the product is applied in the field, less heavy equipment may also be used which reduces costs.
Water Savings: If a low density particle is less porous than other materials, this results in less water demand for the composite system and provide advantages for handling, formulating and finished product benefits. This can result in less water demand, measured as 5, 10, 15 gallons per cubic yard of concrete or more.
Insulative Value: If the low density particle or a percentage of the aggregate used encapsulates air or another gas within it, then an R-Value is inherent in the formulated system. As indicated above, the insulative value may be 1 to 5 per inch.
Improved Fire Resistance (FR): If the low density particle or a percentage of the particles used has inherent FR characteristics, then the finished system may have increased FR characteristics. In some embodiments, the system rates [as a] Class A for fire and smoke according to ASTM E84 standard.
Improved Homogeneity: The size, form, composition, shape, and porosity of the low density particles used, and in conjunction with one or a plurality of additive/admixture components, may result in increased homogeneity of the formulated system. This can be measured by slicing a core of a poured sample in half [and-with] visual separation of lightweight from the top and bottom of the sample of <10%, 15%, 20%, 30%.
Engineered Finished Densities: The ability to design a desired finished density of the formulated system based on using one or more low density particles and additive/admixture(s) while maintaining suitable compressive strengths for the desired application is novel and structurally advantageous in construction or renovation of buildings, structures, floors, roofs, castings, panels, and forms
Improved Packing: By using one or more low density particles of varying sizes, shapes, porosities, compositions and densities to decrease the overall density of the finished system, the interstitial spaces can be minimized and thus the outcome is greater rigidity and/or strength.
Volume Cost: A low density particle or plurality of low density particles may reduce the volume cost of a formulated system when compared with other conventional weight materials.
Carbon Reduction: Using low density lightweight particles can promote carbon capture and/or reduction of carbon footprint. For example, if a packaged mixture is 70 pcf and replaces a conventional product at 140 pcf, one truckload can replace the material shipped in two truckloads of standard material, reducing transportation impact and carbon emissions.
Decreased Structural Stress: The use of low density lightweight particles in composite systems can correspondingly decrease the deadload on a given structure or system and or reduce the required foundation, support beams and design elements. In one embodiment, one inch of ultra lightweight leveler can add 3 pounds per square foot whereas conventional levelers can add up to 10.5 pounds per square foot at one inch to the structure.
Surface Profile/Finish: Using a rounded, low density particle can provide a smoother surface profile for the finished composite system than conventional angular or irregular shaped particles. Rounded, low density particles are also easier to trowel and finish.
System Drying: The use of a low density lightweight particle in cementitious, gypsum and or calcium aluminate based systems can impart faster drying and cure characteristics than traditional aggregates. In some embodiments, less water may be used to achieve proper hydration and flow, thereby requiring less water to be released in the curing stage. In some embodiments, the system can cure hours or days faster than conventional systems.
Set Time: The use of certain admixtures in conjunction with certain low density lightweight particles can optimize working and set times of the systems. In some embodiments, the system can have a delayed set time in order to optimize placement. In some embodiments, the system can set hours or days faster than conventional systems.

The use of low density particles to decrease the weight of formulated systems is attractive for the following industries, markets and applications, including variations and others not listed. Cementing; Concrete, including ready-mix, precast, tilt-up panels, underlayment, block, brick, flooring, restoration, renovation, leveling, roof tiles, cement board, wall board, LWIC, bridge decks, balconies, countertops, shotcrete, grout and grouting, roofing, flowable fill, decorative concrete, CLSM, stucco, plaster, urethane, polyester and/or epoxy concrete and others; Cultured Marble, Mortars and Stucco; Refractory; Foundry; 3D Printing, Forgings and Castings.

Proprietary Low Density Particles: The density, size, shape, composition and porosity of such particles is quintessential to the weight reduction and performance of the composite system.

In one embodiment of the invention, one or more of the low density particles described above may be used as a volume filler in conjunction with other filler materials such as sand, gravel, limestone, clay, and other traditional mineral aggregates.

In one embodiment of the invention, the low density particles may be coated or treated by either a liquid, fluid, gel, gas, powder or solid, or treated in another manner, in order to either improve rheology of the system, modify the static and/or magnetic charge of the particle, affect how the particle couples or bonds with other materials in the system, encapsulate something within the particle, prevent the release of something within the particle or to regulate the release of something from the particle in a controlled manner, or to increase the particle's rigidity. The use of thixotropesand or Rheology Modifiers may include Cellulosics, Fumed Silicas, Functional Chemical and Polymer Resin Systems and other Related Materials. One may also increase the particle's fire and/or chemical resistance through the Zinc Borate or Boric Acid, Chlorinated Paraffin, Antimony Oxide, Alumina Trihydrate, Magnesium Hydroxide, Lime and Related Chemicals. One may also modify the particle's porosity, and/or to render the particle inert or inactive through the use of functional chemical and polymer resin systems and other related materials.

For the purpose of definition, lightweight materials are generally characterized as having specific gravity of much less than 1.0 g/cc, such as 0.005 to 0.85 g/cc, with common ranges from about 0.001 g/cc to 0.01 g/cc, 0.01 to 0.1 g/cc, 0.1 to 0.5 g/cc, 0.5 to 0.8 g/cc. Correspondingly, heavy weight materials are products that have a nominal specific gravity of much greater than 1.0 g/cc, such as clay, calcium carbonate, limestone or sand, or densifiers, 2.4-5.0+g/cc.

Proprietary Use of Chemical Additives, Surface Modifiers, thixotropes, Retardants, Accelerators and/or Admixtures often improve the ability to use the low density particles to successfully achieve weight reduction and desired performance in a formulated gypsum or cementitious system. The use of these specific admixtures in combination with ultra lightweight low density particles is novel in achieving a uniform or homogenous mixture, which in turn preserves compressive strengths. In addition, these admixtures can be used prior to, during or after placement to control when and how the system sets and cures. In some embodiments, the mixture achieves initial set within 60 minutes after being mixed with water. In other embodiments, the mixture achieves initial set between 60 and 130 minutes, and other embodiments, within 130 minutes after being mixed with water. In other embodiments, the mixture achieves initial set after 240 minutes after being mixed with water. Benefits include being able to mix the material when and where you needed to, such as at a ready mix plant, place it without setting up in a hose or mixer apparatus prior to placement, setting prior to finishing, or curing too long so as not being able to top it within the desired timing.

In one embodiment of the invention, a formulated system includes the use of one or more of the following: Acrylic Fiber, Carbon Fiber, Graphene, Stainless Steel Fiber, Basaltic Fiber, Sisal Fiber, Glass Fiber or other Related Fibrous Materials; Calcium Carbonate, Magnesium Carbonate, Silicates, Clay and Talc; Calcium Stearate, Magnesium Stearate, Zinc Stearate; Coloring Agents, Corrosion Inhibitors, Shrinkage Control Agent; Cork; Fly Ash; Foamers and or Defoamers; Fungicide, Mildewcide, Biocide, Rodenticide, Insecticide Admixtures or a Combination Thereof; HRWR, MRWR, Low Range Water Reducer, Plasticizer, Polycarboxylate and Variations Thereof; Metakaolin; Polymer Resin Additive; Retarding and or Accelerating Admixtures, Citric Acid, Tartaric Acid, Air Entraining Agents; Silanes, Silicones, Surfactants, Coupling Agents and Other Resin System Variations and Combinations Thereof; Silica Fume; Sodium Olefin Sulfonate and/or Sodium Hydroxide or Butoxyethanol and/or Glutaraldehyde; thixotropesand or Rheology Modifiers may include Cellulosics, Fumed Silicas, Functional Chemical and Polymer Resin Systems and other Related Materials; Zinc Borate or Boric Acid, Chlorinated Paraffin, Antimony Oxide, Alumina Trihydrate, Magnesium Hydroxide, Mildewcide, Fungicide, Preservatives, Lime and Related Chemicals.

The packaging of the lightweight low density particles, with or without the Chemical Additives, Surface Modifiers, thixotropes, Retardants, Accelerators and/or Admixtures is meaningful to the creation of an easy to use and apply lightweight and ultra lightweight formulated gypsum or cementitious mixture.

Depending on the system use or application, the packaging of the low density lightweight particle(s) with or without the Chemical Additives, Surface Modifiers, Thixotropes, Retardants, Accelerators and/or Admixtures can comprise of one or more of the following:
Pail, bucket, box, bag, sack, drum, tote, gaylord box, supersack/bulk bag, bulk truck, pumper truck, mixer truck and/or rail car as a separate additive/admixture, as an additive/admixture prepack, premixed blend, or mixed en route or on-site which may or may not be added to other ingredients such as may be required to make a formulated system at the desired place and time of use and installation.
The low density particle(s) by itself or themselves or in surface modified or treated derivations may be packaged separately.
The additive(s) and/or admixture(s) blend provides improved resin or binder system adhesion and bonding to the particles resulting in optimized strengths, finish characteristics, surface profile and impermeability properties of the finished system as previously noted. In addition, the use of the ingredients of the additive and/or admixture system or particle coatings can advantageously enhance the low density particle(s) to increase their strength and encapsulate secondary particle components.

By virtue of a low level of porosity, such as under 35%, or minimal paste absorption when subjected to pressure such as under pumping conditions, the use of the lightweight low density particles and/or aggregates used in these systems, the associated preparation, mixing time and energy required to achieve the homogeneous and easy to use low or ultra low density gypsum, concrete or formulated system is a significant advantage and enables multiple options for mixing and delivery, such as the use of ready-mix bulk trucks, mixer trucks or pump trucks, rotor stator pumps and the like for job-site placement.

The fact that these lightweight low density particles and their use in these systems optimize the mixing energy required, mixing time and improved pumping, handling and placement characteristics, which is a significant advantage compared to other lightweight systems that are commonly available.

The efficiency and ease of use resulting from incorporating these pre-mixed and preblended low density lightweight particles in gypsum and/or cementitious systems into a ready-mix bulk truck to achieve mixing, delivery and placement is a significant improvement and benefit for gypsum and concrete applications. Further benefits could include reduced carbon footprint, more payload per truck, more output per day, streamlined labor, batch accuracy, reduced waste such as no bags or supersacks to cleanup, less dust on a jobsite since the material isn't mixed on site, and less jobsite footprint due to not needing to stage the material to mix, adding a water truck, mixing apparatus and more.

In aspects, a low density lightweight gypsum and/or cementitious mix comprises low density lightweight mineral based particles with compressive strengths that are greater than about 2,000 psi and comprising densities within a range from about 55 pcf to about 95 pcf. A mineral based perlite particle is provided comprising a specific gravity within a range from about 0.3 g/cc to about 0.9 g/cc and an average particle size within a range from about 50 microns to about 300 microns in combination with a gypsum and/or cementitious mixture. In aspects, the processed perlite particle may be from about 17 pcf to about 22 pcf bulk density, with an average particle size within a range from about 150 microns to about 200 microns, and a rounded shape with a porosity of less than about 20% to about 35% liquid absorption by weight.

In aspects, the mix may comprise one or more of silicon dioxide, silicon aluminate, vermiculite, perlite, fly ash, cenospheres or glass derived particle with a specific gravity within a range from about 0.1 g/cc to about 0.9 g/cc, or within a range from about 1.8 g/cc to about 2.4 g/cc, and an average particle size within a range from about 20 microns to about 300 microns in combination with a gypsum and/or cementitious mixture. In aspects, also provided are one or more of chemical additives, surface modifiers, Thixotropes, retardants, accelerators and/or admixtures in conjunction with low density lightweight mineral based particles and gypsum or cementitious systems to achieve homogeneity of the mix with separation less than about 20% and an initial set time of within about 60 minutes, or within a range from about 60 minutes to about 130 minutes, or greater than about 130 minutes after being mixed with water.

An ultra low density lightweight gypsum and/or cementitious mix is provided comprising low density lightweight polymer based particles with compressive strengths of greater than about 50 psi and densities within a range from about 15 pcf to about 55 pcf. In aspects, a polymer based low density lightweight particle is provided with an average nominal specific gravity within a range from about 0.001 g/cc to about 0.01 g/cc, from about 0.01 to about 0.1 g/cc, from about 0.1 to about 0.5 g/cc, from about 0.5 to about 0.8 g/cc, from about 0.8 to about 1.25 g/cc. In aspects, these lightweight low density particles can have an average particle size within a range from about 1 to 15 microns, from about 10 microns to about 200 microns, from about 40 microns to about 300 microns, from about 200 microns to about 1,000 microns, from about 0.4 mm to about 2 mm, from about 1 mm to about 3 mm, from about 2 mm to about 4 mm, from about 3 mm to about 8 mm.

In aspects, the low density lightweight particles can comprise one or more of polymers and/or copolymers, including but not limited to one or more of polyolefin, PP, EPP, LDPE, HDPE, EPE, Polystyrene, EPS, PPO, carbon or graphite modified polymers, PVC, PVDC, PMU, melamine, polyester, ABS, polyamide, urethane, epoxy, foamed rubber, crumb rubber, EPDM, and the like. In aspects, also provided is the use of chemical additives, surface modifiers, Thixotropes, retardants, accelerators and/or admixtures in conjunction with low density lightweight polymer based particles and gypsum or cementitious systems to achieve homogeneity of the mix of separation less than about 20% and an initial set time of within about 60 minutes, or within a range from about 60 minutes to about 130 minutes, or greater than about 130 minutes after being mixed with water.

In aspects, a gypsum and/or cementitious mixture can have a controlled working or set time of at least 30 minutes to enable the delivery of the system via a mixer truck, pump truck, bulk truck or ready mix truck and the like. In aspects, the mixture has a density of less than about 130 pcf and has a controlled working or set time of at least 60 minutes. In aspects, a low density lightweight gypsum and/or cementitious mix comprises low density lightweight mineral based particles with compressive strengths of greater than about 2,000 psi and densities within a range from about 55 pcf to about 95 pcf. In aspects, an ultra low density lightweight gypsum and/or cementitious mix can comprise low density lightweight polymer based particles with compressive strengths of greater than about 50 psi and densities within a range from about 15 pcf to about 55 pcf. In aspects, a conventional gypsum and/or cementitious mixture is provided with densities of between 90 and 115 pcf and 110 and 130 pcf with compressive strengths of up to 2,000 psi, 2,500 psi, 3,000 psi, 3,500 psi, 4,000 psi, 4,500 psi, 5,000 psi, 5,500 psi and greater. In aspects, also provided is the use of chemical additives, surface modifiers, Thixotropes, retardants, accelerators and/or admixtures in conjunction with low density lightweight polymer based particles and gypsum or cementitious systems to achieve homogeneity of the mix of separation less than about 20% and an initial set time of within about 60 minutes, or within a range from about 60 minutes to about 130 minutes, or greater than about 130 minutes after being mixed with water. In aspects, the chemistry and particles in the mix design can accommodate initial set time within one hour or delayed up to 12 hours. The initial set of the mixture can be accelerated or retarded through the use of a supplemental chemical or other activators for use on-site. In aspects, the density is within a range from about 60 pcf to about 130 pcf and the compressive strength is greater than about 10,000 psi.

Example gypsum and cementitious concrete formulations of the present invention are provided below.

Example Formula 1

| Product | Percentages By Volume |
|---|---|
| Gypsum or Cement or | 35-65% |
| Pozzolan | |
| Fine Aggregates; 1 or | 0-25% |
| more | |
| Coarse Aggregates; 1 or | 0-25% |
| more | |
| Additives/Admixtures; 1 | 0-15% |
| or more | |
| Low Density Lightweight | 30-65% |
| Particle(s); 1 or more | |
| Density | 55-95 pcf |
| Compressive Strength | After the lightweight concrete |
| | composition is set for 28 days, it has a |
| | compressive strength of at least 2,000 |
| | psi, or 2,500 psi, or 3,000 psi, or 3,500 |
| | psi, or 4,000 psi, or 4,500 psi. |

Example Formula 2

| Product | Percentages By Volume |
|---|---|
| Gypsum or Cement or | 8-30% |
| Pozzolan | |
| Fine Aggregates; 1 or more | 0-20% |
| Coarse Aggregates; 1 or | 0-20% |
| more | |
| Additives/Admixtures; 1 or | 0-15% |
| more | |
| Low Density Lightweight | 60-90% |
| Particle(s); 1 or more | |
| Density | 15-55 pcf |
| Compressive Strength | After the lightweight |
| | concrete composition is set for 28 |
| | days, it has a compressive strength |
| | of at least 50 psi, 100 psi, or 150 psi, |
| | or 200 psi, or 250 psi, or 300 psi, or |
| | 350 psi, or 400 psi, or 450 psi, or |
| | 500 psi, or 550 psi, or 600 psi, or |
| | 650 psi. |

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter.

It should be understood that while various aspects have been described in detail relative to certain illustrative and specific examples thereof, the present disclosure should not be considered limited to such, as numerous modifications and combinations of the disclosed features are possible without departing from the scope of the following claims.

What is claimed is:

1. A composition comprising:
a low density lightweight gypsum or cementitious mix comprising low density lightweight mineral based particles with compressive strengths of greater than 2,000 psi and densities within a range from about 55 pcf to about 95 pcf.

2. The composition of claim 1, further comprising a mineral based perlite particle with a specific gravity of between 0.3 g/cc to 0.9 g/cc and an average particle size of 50 to 300 microns in combination with the gypsum or cementitious mix.

3. The composition of claim 1, further comprising silicon dioxide, silicon aluminate, vermiculite, perlite, fly ash, cenospheres or glass derived particle with a specific gravity of 0.1 to 0.9 g/cc or 1.8 to 2.4 g/cc and average particle size of 20 to 300 microns in combination with a gypsum and/or cementitious mixture.

4. The composition of claim 1, further comprising one or more of chemical additives, surface modifiers, Thixotropes, retardants, accelerators or admixtures in conjunction with low density lightweight mineral based particles and gypsum or cementitious systems to achieve homogeneity of the mix of separation less than about 20% and an initial set time within a range from about 60 minutes to about 130 minutes after being mixed with water.

5. A composition comprising:
an ultra low density lightweight gypsum or cementitious mix comprising low density lightweight polymer based particles with compressive strengths of greater than 50 psi and densities within a range from about 15 pcf to about 55 pcf.

6. The composition of claim 5, wherein the low density lightweight polymer based particles comprise an average nominal specific gravity within a range from about 0.001 g/cc to about 1.25 g/cc.

7. The composition of claim 5, wherein the low density lightweight polymer based particles comprise an average particle size within a range from about 1 micron to about 8 mm.

8. The composition of claim 5, wherein the low density lightweight polymer based particles comprise polymers and copolymers, comprising one or more of polyolefin, PP, EPP, LDPE, HDPE, EPE, Polystyrene, EPS, PPO, carbon or graphite modified polymers, PVC, PVDC, PMU, melamine, polyester, ABS, polyamide, urethane, epoxy, foamed rubber, crumb rubber, or EPDM.

9. The composition of claim 5, further comprising one or more chemical additives, surface modifiers, Thixotropes, retardants, accelerators, or admixtures in conjunction with low density lightweight polymer based particles and gypsum or cementitious systems to achieve homogeneity of the mix of separation less than about 20% and an initial set time within a range from about 60 minutes to about 130 minutes after being mixed with water.

10. A gypsum or cementitious mixture having a density of less than about 130 pcf and having a controlled working or set time of at least 60 minutes to enable the delivery of the system via a mixer truck, pump truck, bulk truck or ready mix truck.

11. The gypsum or cementitious mixture of claim 10, further comprising a low density lightweight gypsum or cementitious mix comprising low density lightweight mineral based particles with compressive strengths of greater than 2,000 psi and densities within a range from about 55 pcf to about 95 pcf.

12. The gypsum or cementitious mixture of claim 10, further comprising an ultra low density lightweight gypsum or cementitious mix comprising low density lightweight polymer based particles with compressive strengths of greater than 50 psi and densities within a range from about 15 pcf to about 55 pcf.

13. The gypsum or cementitious mixture of claim 10, further comprising a conventional gypsum or cementitious mixture with densities within a range from about pcf to about 130 pcf with compressive strengths of up to 5,500 psi.

14. The gypsum or cementitious mixture of claim 10, further comprising one or more chemical additives, surface modifiers, thixotropes, retardants, accelerators, or admixtures in conjunction with low density lightweight mineral and/or polymer based particles and gypsum or cementitious systems to achieve homogeneity of the mix of separation less than about 20% and an initial set time within a range from about 60 minutes to about 130 minutes after being mixed with water.

15. The gypsum or cementitious mixture of claim 10, wherein the chemistry and particles in the mix design accommodate initial set time within one hour or delayed up to 12 hours.

16. The gypsum or cementitious mixture of claim 15, wherein the initial set of the mixture is accelerated or retarded through the use of a supplemental chemical or other activators for use on-site.

17. The gypsum or cementitious mixture of claim 10, wherein the density is within a range from about 60 pcf to about 130 pcf and the compressive strength is greater than about 10,000 psi.
